(19) United States
(12) Patent Application Publication
(10) Pub. No.: US 2019/0325331 A1
(43) Pub. Date: Oct. 24, 2019

(54) STREAMLINED FRAMEWORK FOR IDENTIFYING AND IMPLEMENTING FIELD DEVELOPMENT OPPORTUNITIES

(71) Applicant: QRI GROUP, LLC., Houston, TX (US)

(72) Inventors: Wassim Benhallam, Houston, TX (US); Amir Salehi, Houston, TX (US); Hamed Darabi, Houston, TX (US); David Castineira, Cambridge, MA (US); Aaron D. Close, Katy, TX (US); Richard J. Heil, Houston, TX (US)

(21) Appl. No.: 16/389,086

(22) Filed: Apr. 19, 2019

Related U.S. Application Data
(60) Provisional application No. 62/660,520, filed on Apr. 20, 2018.

(51) Int. Cl. G06N 5/04; G06N 20/00; E21B 41/00

(52) U.S. Cl. CPC G06N 5/048; E21B 41/0092; G06N 20/00

(57) ABSTRACT

Embodiments are directed to identifying and implementing hydrocarbon production opportunities including recompletion opportunities, new vertical drill target opportunities, and horizontal or deviated well target opportunities. Computer systems access multi-disciplinary data, perform data validation and pre-processing on the data, identify field development opportunities by identifying candidates, forecasting production at those candidates, generating an uncertainty quantification, and vetting and validating the data. The computer systems then list the viable well target opportunities including recompletion opportunities, vertical new drill target opportunities and deviated and horizontal target opportunities.

### CROSS-REFERENCE TO RELATED APPLICATION

This application claims the benefit of U.S. Provisional Application No. 62/660,520, filed Apr. 20, 2018, the disclosure of which is incorporated herein by reference in its entirety.

### BACKGROUND

A Hydrocarbon Field Development Plan (FDP) establishes the number of wells to be drilled to reach production objectives; the recovery techniques to be used to extract the fluids within the reservoir; the type and cost of installations; the separation systems for gas and fluids; and the treatment systems needed to preserve the environment. Mature brownfield assets can present a daunting challenge to subsurface modelers: thousands of wells, commingling production and injection from dozens of layers, over many decades for most fields. The modeling and history matching workflow for such assets can be achieved with a team of experienced modelers working carefully; however, even with recent advances in full-field modeling, reduced order, multiscale, and upscaling modeling techniques, the time horizon is usually measured in months.

This poses two challenges to oil and gas companies without the time and/or resources to devote to a large technical team working for many months: 1) how can new field development plans be created to actively manage and optimize mature oil fields? and 2) how can production be forecasted in order to accurately evaluate assets? In these scenarios, data-driven approaches offer a solution. The problems that make modeling of mature assets difficult and time consuming—large data sets, high well counts, complex stratigraphy, etc.—can actually strengthen the confidence of techniques that rely on data-driven forecasting methodologies.

In the past, a few attempts have been made to use the data-driven approach for identifying and forecasting field development opportunities. Although limited papers have been published for the application of data mining and machine learning techniques in very specific modules of FDP identification process, there is no comprehensive method and workflow to combine all these technologies to conduct automated identification and production forecasts of field development opportunities. The FDP provided usually consists of specific opportunities in the areas of well operations, recompletion targeting pay-behind-pipe, new drill locations, sidetrack opportunities, and optimal horizontal targets.

### BRIEF SUMMARY

Embodiments described herein are directed to identifying and implementing hydrocarbon production opportunities including recompletion opportunities, new vertical drill target opportunities, and horizontal or deviated well target opportunities. In one embodiment, a computer system accesses petrophysical log data obtained at a hydrocarbon extraction site to generate a geological map of the site. The computer system also accesses historical completion data for the hydrocarbon extraction site to identify uncontacted net pay intervals that represent material remaining in hydrocarbon wells on the hydrocarbon site. Next, the computer system analyzes isolated and connected intervals of the hydrocarbon wells to determine, according to the geological map, which portions of the hydrocarbon wells have been drained by existing completions.

Continuing this embodiment, the computer system forecasts, using statistical characterization methods and machine learning algorithms, projected production results for recompletion opportunities at the hydrocarbon site. The projected production results include initial production estimates and/or ultimate recovery estimates. The computer system calculates a level of geologic uncertainty relative to the forecasted production results and determined drainage, where the geologic uncertainty levels indicate levels of risk. The computer system also filters a list of recompletion opportunities for selection according to geological feasibility, mechanical feasibility and/or engineering feasibility, and, at least in some embodiments, initiates hydrocarbon production at the recompletion opportunity.

In another embodiment, a computer system identifies new vertical drill target opportunities. The computer system accesses geological, petrophysical or engineering data related to a hydrocarbon extraction site, and analyzes the accessed data to identify grid regions in the hydrocarbon extraction site that are fit for placing new wells according to well placement constraints. The computer system then generates a relative probability of success (RPOS) mapping for each zone that ranks the identified regions according to zone-mappable attributes associated with productive hydrocarbon wells, and further forecasts, for each new drill location, a potential production rate for one or more target zones.

The computer system also estimates the variability associated to the potential fluid rates using statistical characterization of existing injection and production sources in the reservoir. It also determines, based on geological, petrophysical and geophysical-related factors, a geologic risk evaluation for a given target opportunity. The risk measurement indicates both the interactivity of the dynamic system and the heterogeneity description of the geological system, including any potential aquifer. The computer system then produces a list of new vertical drilling prospects for selection according to geological likelihood, operational constraints and/or reservoir management factors, and, at least in some embodiments, initiates hydrocarbon production at the selected new vertical drilling opportunity.

In another embodiment, a computer system is provided for identifying horizontal or deviated well target opportunities. The computer system includes a processor, system memory and a data accessing module configured to access geological, petrophysical or engineering data related to a hydrocarbon extraction site. The computer system further includes a domain identifier configured to identify potential regions that satisfy stratigraphic, spatial and depth constraints within the hydrocarbon extraction site, as well as a spatial analyzer configured to perform a 3D spatial analysis of the identified potential well placement zones within the hydrocarbon extraction site.

The computer system also includes a drainage analyzer configured to identify zones of the hydrocarbon extraction site that include drained portions that have been drained by existing wells on the site, along with a 3D map generator configured to generate a relative probability of success (RPOS) 3D map that ranks the identified zones of the site according to zone-mappable attributes associated with productive hydrocarbon wells. Still further, the computer system includes a well target identifier configured to search the 3D map to identify optimal target locations for horizontal or deviated wells according to the RPOS 3D map and well placement constraints including azimuth, target length, deviation range or others as defined by a user. Also part of the computer system are an optimization module configured to perform an interference analysis designed to select an optimal set of non-interfering well candidates, a forecasting module configured to forecast an initial production rate for the selected horizontal well placement candidate placed in the identified location on the hydrocarbon extraction site using analytical, simulation, or machine learning models, and a production initiator configured to initiate hydrocarbon production at the selected horizontal well placement candidate in the identified location.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including identifying and implementing hydrocarbon production opportunities including recompletion opportunities, new vertical drill target opportunities, and horizontal or deviated well target opportunities.

FIGS. 2A and 2B illustrate a unified flowchart for identifying and implementing hydrocarbon production opportunities including recompletion opportunities, new vertical drill target opportunities, and horizontal or deviated well target opportunities.

FIG. 3 illustrates a summary of behind-pipe opportunity identification workflow.

FIG. 4 includes charts illustrating different ways of identifying drained net pay depending on the extent of vertical fractures as well as the adopted perforation strategy.

FIG. 5 illustrates the process of merging or aggregating pulsed neutron log curves obtained from multiple log runs.

FIG. 6 includes charts illustrating extraction of oil saturation pseudo logs from simulation models.

FIG. 7 illustrates a drainage map overlaying hydrocarbon pore thickness (HCPT) contours where drained areas are colored by drainage index.

FIG. 8 illustrates a keyword scoring input in a parameters file including a keyword sheet and a score sheet.

FIG. 9 illustrates a summary of new drill locations identification workflow.

FIG. 10 illustrates a spacing grid created based on well heads and trajectories.

FIG. 11 illustrates an example zone relative probability of success (RPOS) map along with an example set of zone input maps.

FIG. 12 illustrates a summary of horizontal/deviated target identification workflow.

FIG. 13 illustrates a polygon defining a spatial region of interest, and a cross section showing cells of interest.

FIG. 14 illustrates a 3D cylinder around existing wells, and spacing properties showing conflicting cells.

FIG. 15 illustrates examples of drained pay, drained volumes, and well drained mesh with perforations.

FIG. 16 illustrates trends in various attributes used to create a POS model property.

FIG. 17 illustrates a flowchart of an example method for identifying and implementing hydrocarbon production opportunities including recompletion opportunities.

FIG. 18 illustrates a flowchart of an example method for identifying and implementing hydrocarbon production opportunities including recompletion new vertical drill target opportunities.

FIG. 19 illustrates a flowchart of an example method for identifying and implementing hydrocarbon production opportunities including horizontal or deviated well target opportunities.

### DETAILED DESCRIPTION

Embodiments described herein are directed to identifying and implementing hydrocarbon production opportunities including recompletion opportunities, new vertical drill target opportunities, and horizontal or deviated well target opportunities. In one embodiment, a computer system accesses petrophysical log data obtained at a hydrocarbon extraction site to generate a geological map of the site. The computer system also accesses historical completion data for the hydrocarbon extraction site to identify uncontacted net pay intervals that represent material remaining in hydrocarbon wells on the hydrocarbon site. Next, the computer system analyzes isolated and connected intervals of the hydrocarbon wells to determine, according to the geological map, which portions of the hydrocarbon wells have been drained by existing completions.

Continuing this embodiment, the computer system forecasts, using statistical characterization methods and machine learning algorithms, projected production results for recompletion opportunities at the hydrocarbon site. The projected production results include initial production estimates and/or ultimate recovery estimates. The computer system calculates a level of geologic uncertainty relative to the forecasted production results and determined drainage, where the geologic uncertainty levels indicate levels of risk. The computer system also filters a list of recompletion opportunities for selection according to geological feasibility, mechanical feasibility and/or engineering feasibility, and initiates hydrocarbon production at the recompletion opportunity.

In another embodiment, a computer system identifies new vertical drill target opportunities. The computer system accesses geological, petrophysical or engineering data related to a hydrocarbon extraction site, and analyzes the accessed data to identify well placement grid cells in the hydrocarbon extraction site that are fit for placing new wells according to well placement constraints. The computer system then generates a relative probability of success (RPOS) mapping for each zone that ranks the identified well placement grid cells according to zone-mappable attributes associated with productive hydrocarbon wells, and further forecasts, for each new drill location, a potential production rate for one or more target zones.

The computer system also estimates the probability of exceeding or falling short of the forecasted potential production rate using at least a portion of neighborhood production data indicating an amount that wells in neighboring zones are producing, and determines, based on geologic factors related to the hydrocarbon site, a geologic risk measurement for a given target opportunity. The risk measurement incorporates the heterogeneity of the reservoir and the quality of the geological modeling work. The computer system then filters a list of new vertical drilling opportunities for selection according to geological feasibility, operational constraints, and/or engineering feasibility, and initiates hydrocarbon production at the selected new vertical drilling opportunity.

In another embodiment, a computer system is provided for identifying horizontal or deviated well target opportunities. The computer system includes a processor, system memory and a data accessing module configured to access geological, petrophysical or engineering data related to a hydrocarbon extraction site. The computer system further includes a domain identifier configured to identify potential regions that satisfy stratigraphic, spatial and depth constraints within the hydrocarbon extraction site, as well as a spatial analyzer configured to perform a 3D spatial analysis of the identified potential well placement zones within the hydrocarbon extraction site.

The computer system also includes a drainage analyzer configured to identify zones of the hydrocarbon extraction site that include drained portions that have been drained by existing wells on the site, along with a 3D map generator configured to generate a relative probability of success (RPOS) 3D map that ranks the identified zones of the site according to zone-mappable attributes associated with productive hydrocarbon wells. Still further, the computer system includes a well target identifier configured to search the 3D map to identify optimal target locations for horizontal or deviated wells according to the RPOS 3D map and well placement constraints including azimuth, target length, deviation range or others as defined by a user. Also part of the computer system are an optimization module configured to perform an interference analysis designed to filter through and select an optimal set of non-interfering well candidates, a forecasting module configured to forecast an initial production rate for the selected horizontal well placement candidate placed in the identified location on the hydrocarbon extraction site using analytical, simulation, or machine learning models, and a production initiator configured to initiate hydrocarbon production at the selected horizontal well placement candidate in the identified location.

The following discussion refers to a number of methods and method acts that may be performed by one or more embodiments of the subject matter disclosed herein. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

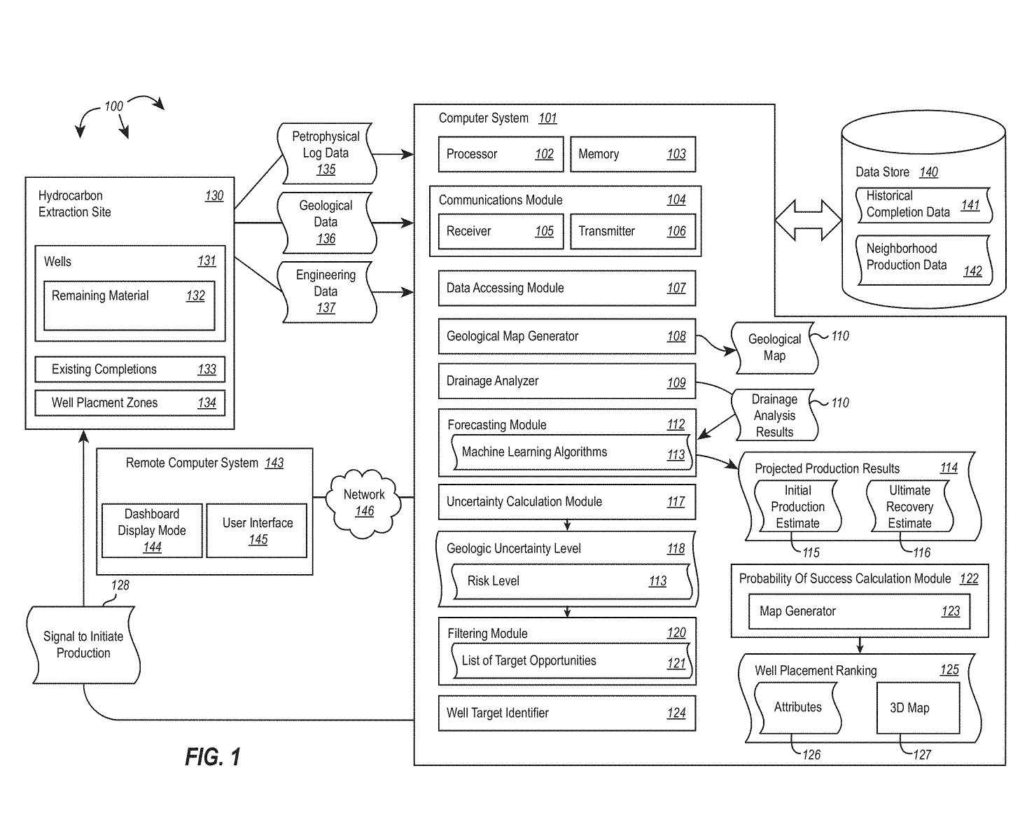

Referring to the figures, FIG. 1 illustrates a computer architecture 100 in which at least one embodiment described herein may be employed. The computer architecture 100 includes a computer system 101. The computer system 101 includes at least one processor 102 and at least some system memory 103. The computer system 101 may be any type of local or distributed computer system, including a cloud computer system. The computer system 101 includes modules for performing a variety of different functions. The program modules may be hardware-based, software-based, or a combination thereof. Each program module uses computing hardware and/or software to perform functions including those defined herein below.

For instance, communications module 104 may be configured to communicate with other computer systems. The communications module 104 may include any wired or wireless communication means that can receive and/or transmit data to or from other computer systems. For example, the communications module 104 may include a hardware receiver 105 and a hardware transmitter 106. The receiver 105 and/or the transmitter 106 may be configured to interact with databases, mobile computing devices (such as mobile phones or tablets), embedded or other types of computer systems. The communications module 104 may receive data from a hydrocarbon extraction site 130 (e.g. from sensors running within or around the wells 131). The data may include petrophysical data 135, geological data 136, engineering data 137 or other data related to the production of hydrocarbons at the site 130. As will be explained further below, other modules of FIG. 1 may be used to perform functions including identifying and implementing hydrocarbon production opportunities including recompletion opportunities, new vertical drill target opportunities, and horizontal or deviated well target opportunities.

Computing architecture 100 may also include one or more remote computers 143 that permit a user, team of users, or multiple parties to access information generated by main computer system 101. For example, each remote computer 143 may include a dashboard display module 144 that renders and displays dashboards, metrics, or other information relating to reservoir production, alarms, anomaly detection, etc. Each remote computer 143 may also include a user interface 145 that permits a user to make adjustment to production at the hydrocarbon extracton site 130. Each remote computer 143 may also include a data storage device (not shown).

Individual computer systems within computer architecture 100 (e.g., main computer system 101 and remote computers 143) can be connected to a network 146 using the communications module 104, such as, for example, a local area network (“LAN”), a wide area network (“WAN”), or even the Internet. The various components can receive and send data to each other, as well as other components connected to the network 146. Networked computer systems (i.e. cloud computing systems) and computers themselves constitute a “computer system” for purposes of this disclosure.

Networks facilitating communication between computer systems and other electronic devices can utilize any of a wide range of (potentially interoperating) protocols including, but not limited to, the IEEE 802 suite of wireless protocols, Radio Frequency Identification (“RFID”) protocols, ultrasound protocols, infrared protocols, cellular protocols, one-way and two-way wireless paging protocols, Global Positioning System (“GPS”) protocols, wired and wireless broadband protocols, ultra-wideband “mesh” protocols, etc. Accordingly, computer systems and other devices can create message related data and exchange message related data (e.g., Internet Protocol (“IP”) datagrams and other higher layer protocols that utilize IP datagrams, such as, Transmission Control Protocol (“TCP”), Remote Desktop Protocol (“RDP”), Hypertext Transfer Protocol (“HTTP”), Simple Mail Transfer Protocol (“SMTP”), Simple Object Access Protocol (“SOAP”), etc.) over the network.

Computer systems and electronic devices may be configured to utilize protocols that are appropriate based on corresponding computer system and electronic device on functionality. Components within the architecture can be configured to convert between various protocols to facilitate compatible communication. Computer systems and electronic devices may be configured with multiple protocols and use different protocols to implement different functionality.

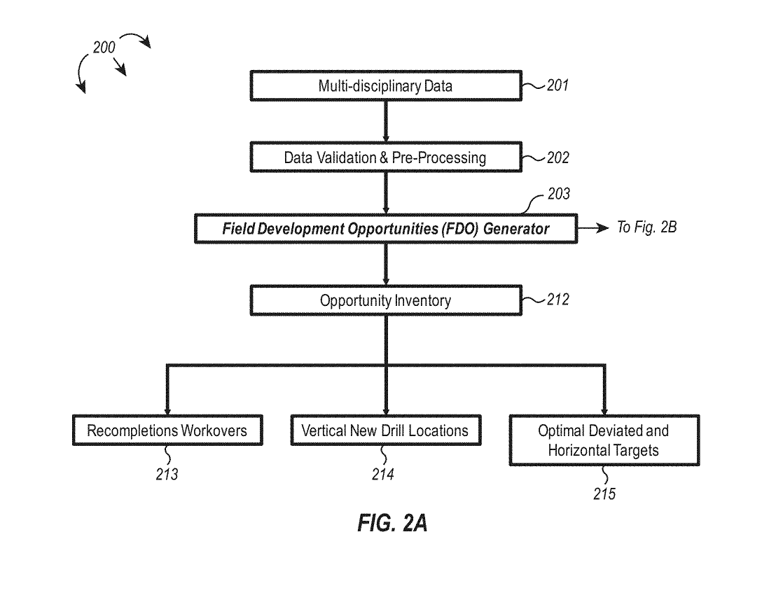

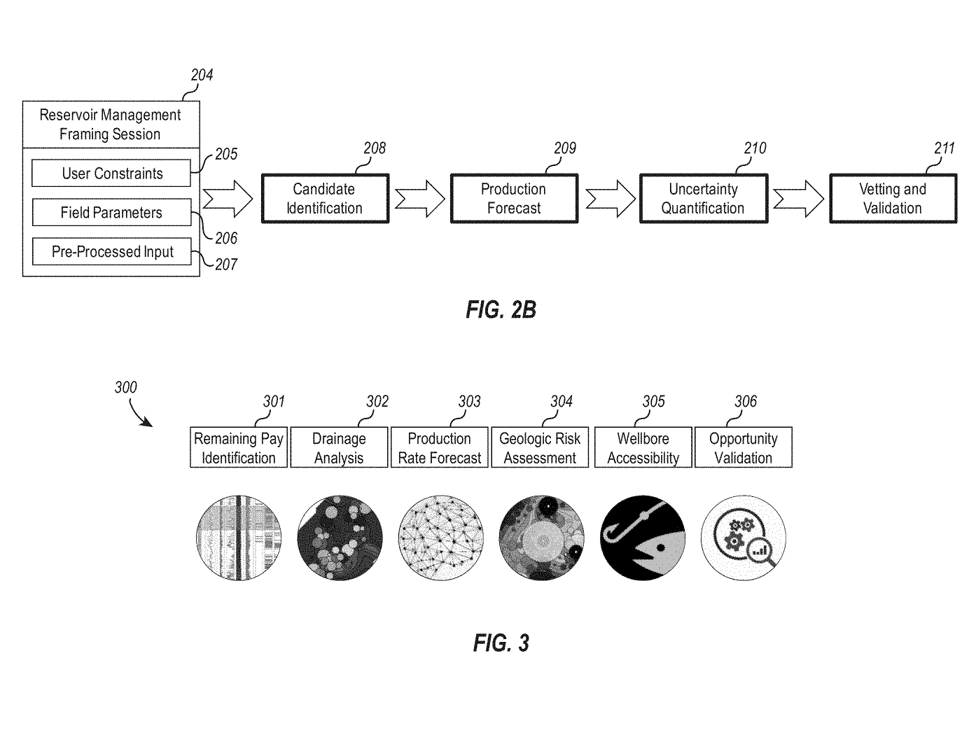

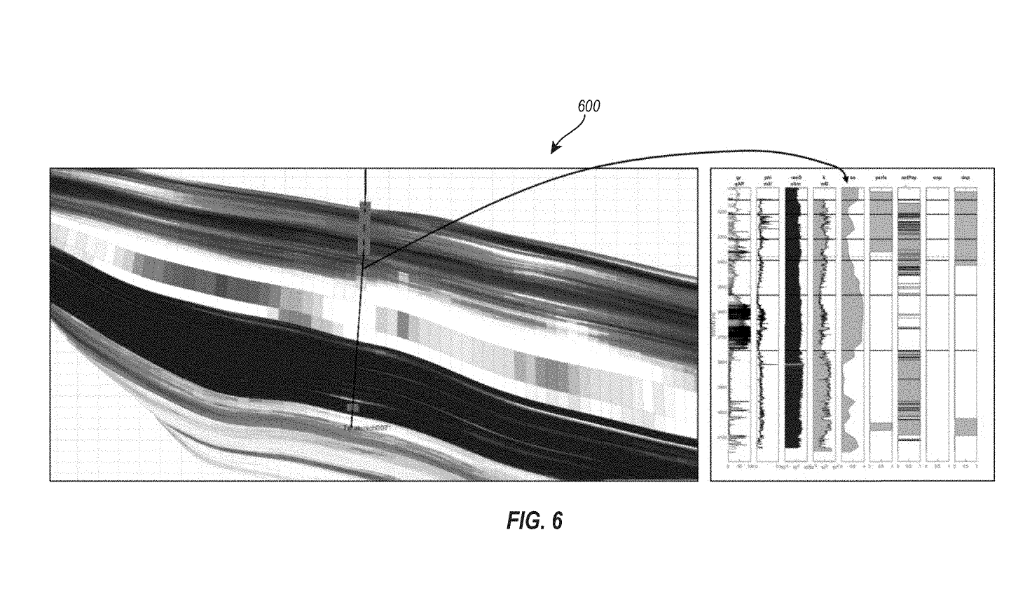

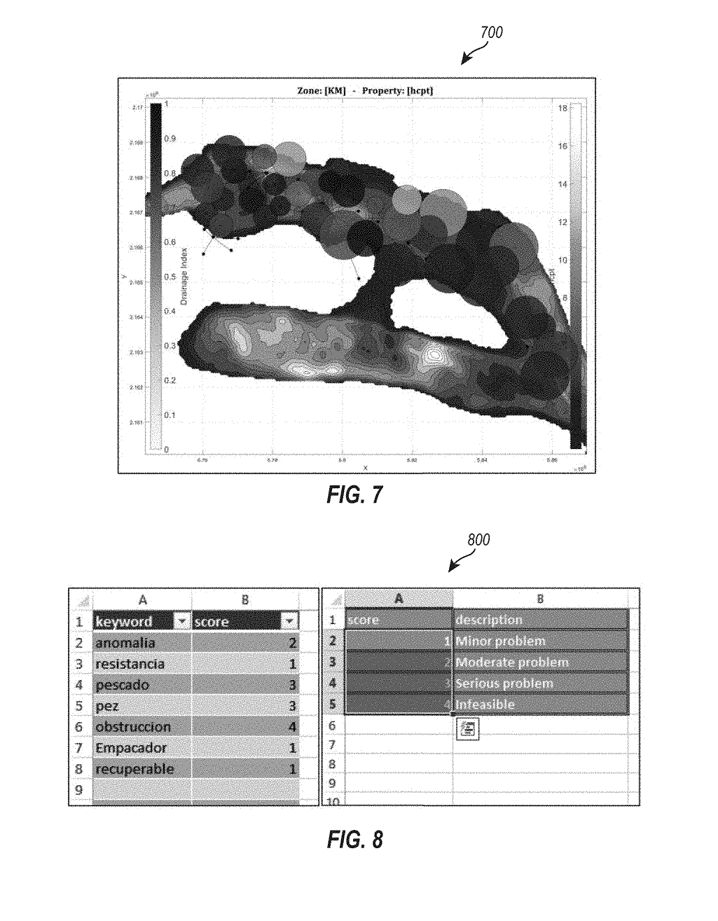

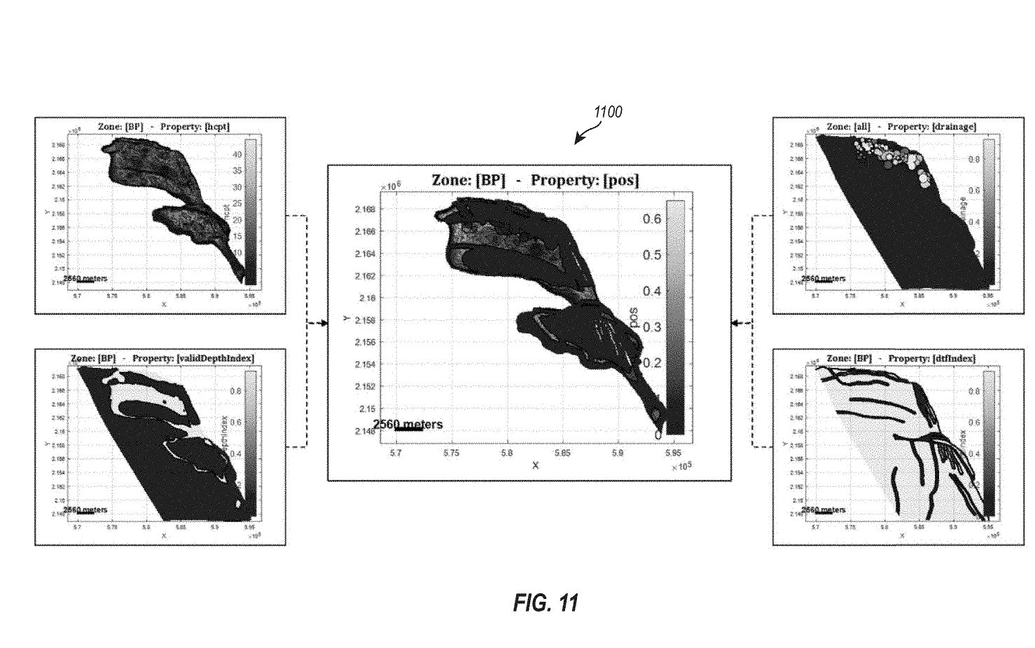

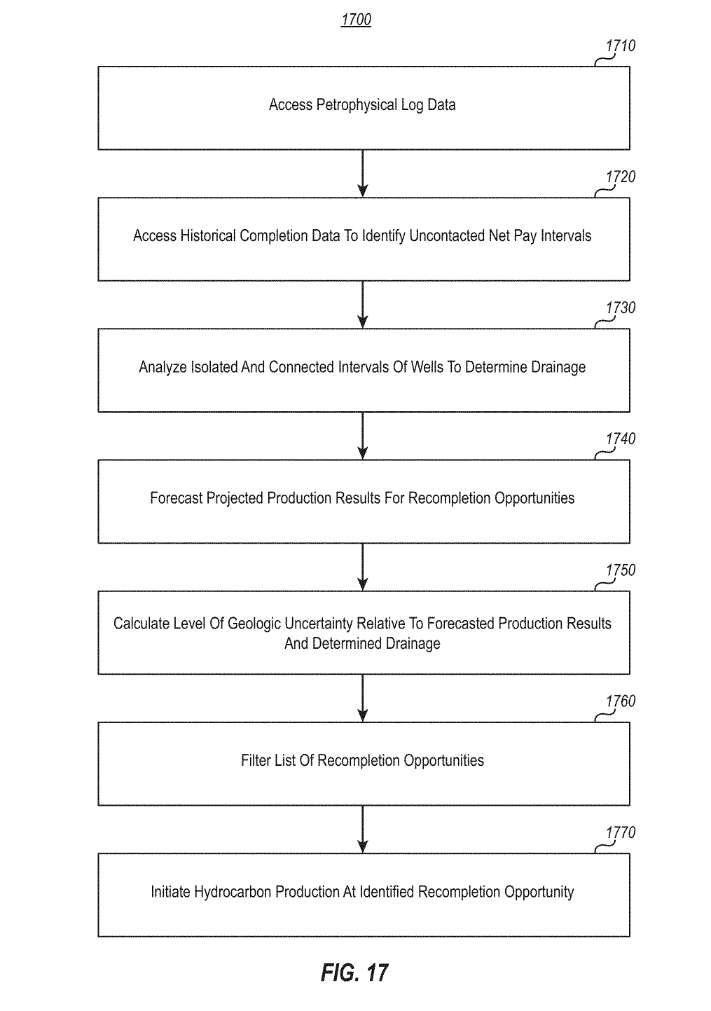

Indeed, as shown in flowchart 200 of FIGS. 2A and 2B, different methods and systems may be provided for identifying recompletion, new and horizontal well target opportunities. Each method and system may include common elements as well as unique elements. At least in some embodiments, each of the methods and systems accesses multi-disciplinary data (e.g. petrophysical, geological and/or engineering data) at 201, and then perform some type of data validation and pre-processing at 202. A field development opportunities generator 203 may conduct a reservoir management framing session (204 of FIG. 2B) in which user constraints 205, field parameters 206, and pre-processed inputs 207 are used to perform candidate identification 208, to generate production forecasts 209, to generate an uncertainty quantification 210, and to perform vetting and validation 211. The opportunities are stored in opportunity inventory 212, and may be individually provided to users and/or hydrocarbon extraction sites. The methods and systems for determining recompletion opportunities 213, vertical new drill locations 214 and deviated and horizontal targets 215 will be explained further below with regard to FIGS. 3-16, as well as method FIGS. 17-19.

The embodiments provided herein include a fully automated platform that applies advanced computational algorithms and data mining techniques on multi-disciplinary datasets to identify various remaining, feasible, and actionable field development opportunities. These include recompletion behind-pipe opportunities, vertical new drill locations, sidetrack opportunities, and optimal deviated/horizontal targets. The platform can also be used to identify custom types of opportunities such as reactivation opportunities. The platform implements inter-disciplinary field data including well surveys, well logs, well formation tops, completion and perforation data, production data, fluid contacts data, static geologic models, simulation models, and other types of data. When specific data inputs are missing or partially available, the platform provides algorithms that generate or complete the partial data. For instance, when formation tops are missing or incomplete, the platform uses advanced time series algorithms such as customized dynamic time warping to correlate a few validated formation tops across the field.

To identify these opportunities (212), the embodiments herein automate multiple geologic and engineering workflows including remaining pay interpretation, drainage analysis, geoengineering attribute mapping, production forecast, uncertainty quantification, and mechanical feasibility assessment to list a few. For each one of these modules, the user has access to several parameters that can be used to customize the inner mechanics of various algorithms which helps adapt the workflow to unique field-specific complexities such as depositional environment, fracture prevalence, extensive baffle layers, vertical communication, and reservoir compartmentalization.

Traditional workflows to identify development opportunities are labor-intensive and typically require the involvement of an interdisciplinary team for several months. Despite this long work timeframe, many opportunities remain unexploited because of incorrect or outdated data interpretation. In addition, the methods used in this traditional process are not standardized, are left to the discretion of the engineer/geoscientist, do not guarantee optimal solutions, and are often limited to the confines of one discipline. In contrast, the automated approach herein delivers initial results using integrated multidisciplinary data in a matter of minutes, and allows for multiple updates and iterations to be made, which ultimately improves the overall accuracy and quality of the final opportunities. In fact, this framework has been successfully applied to several giant mature assets in locations throughout the world, with massive data set and complexity and in situations where static and dynamic reservoir models are unavailable, partially available, or are very out of date.

Hundreds of behind-pipe opportunities, sweet spots, and optimal deviated or horizontal opportunities have been identified for each field.

In summary, the embodiments herein can provide one or more of the following: 1) execution time is very fast and an initial opportunity inventory can be generated in a matter of seconds, 2) the user can choose from multiple algorithms and methods to fully customize the technology to unique field/reservoir complexities, and 3) core algorithms are data-driven, integrate multi-disciplinary datasets, and leave little room to the biases or subjectivity of the user which allows for a consistent and repeatable analysis.

A Field Development Plan (FDP) establishes the number of wells to be drilled to reach production objectives: the recovery techniques to be used to extract the fluids within the reservoir, the type and cost of installations, the separation systems for gas and fluids, and the treatment systems needed to preserve the environment. A low oil price environment presents a distinct challenge to the process of field development planning and reserves estimation. Operating companies around the world have been left with large portfolios of mature assets whose field development plans (FDPs) and associated reserves are no longer economically feasible. These plans must be retooled away from capital intensive investments toward reservoir management and field optimization.

To identify a list of development opportunities (212), the systems herein automate geologic and engineering workflows including remaining pay interpretation, drainage analysis, geo-engineering attribute mapping, production forecast, uncertainty quantification, and mechanical feasibility assessment. For each of these modules, users may have access to several parameters that can be used to customize the way the algorithm operates and may be able to adapt the workflows to unique field-specific challenges. These embodiments also include tools to automate processes critical to the process of opportunity identification.

As shown in chart 300 of FIG. 3, an automated pay-behind-pipe workflow is shown. The workflow to identify recompletion opportunities targeting pay-behind-pipe includes several sequential modules (301-306). The main modules are listed below:

1. A geological mapping is generated which includes a 2.5D property model using log and formation top data to identify uncontacted net pay intervals (i.e. remaining pay 301). 2. A drainage analysis module estimates areas that have been drained by existing completions (302). 3. A production forecast module forecasts production for behind-pipe opportunities using various methods outlined below (303). 4. A confidence estimation module estimates geologic uncertainty and probability of exceeding the estimates (304). 5. A mechanical feasibility module assesses feasibility of opportunities using digitized wellbore diagrams (305), and 6. An attribute filtering module filters opportunities using a range of geologic and engineering attributes (306).

Based on petrophysical log data, geological maps are prepared for specified geological properties (e.g. rock properties), leading to pay identification. These maps are used to understand the spatial distribution of oil in place which forms the foundation for the pay behind pipe and new drill identification workflows. The first step in the workflow is vetting of petrophysical characterization and key parameters by a petrophysicist or other field expert.

For brownfields with complex stratigraphy, a machine-assisted stratigraphic correlation tool may be implemented that correlates user-provided formation tops across the field. This tool uses time series similarity assessment algorithms to find the optimal time alignment between two time series. The algorithm has been customized herein to take as input vetted formation top picks (i.e. manually validated/picked by a geologist) in a few key wells called pivot wells. The algorithm then proceeds to correlate these vetted interpretations from the pivot wells to their corresponding dependent wells.

Given the corrected logs provided by the petrophysicist, and the validated/corrected stratigraphic correlation discussed above, a semi-automated workflow enables the streamlined construction of a 2.5D geological model. These workflows allow the incorporation of hard data points from logs as well as generic depositional trends specific to each zone (e.g. major fluvial/channel orientations) to quickly create fit-for-purpose models and maps. Despite the fact that 2.5D models have lower vertical resolution (i.e. one vertical cell per stratigraphic zone) compared to conventional 3D models, they capture the same lateral trends for any given zone and have the added benefit of being easier to maintain and quality check.

As the term is used herein, “behind-pipe” opportunities refer to target intervals that contain unswept oil in existing wells, which require additional recompletions for production. The identification of behind-pipe opportunities is accomplished through a multi-step workflow that integrates both geologic and engineering data, and that starts with the identification of uncontacted pay intervals.

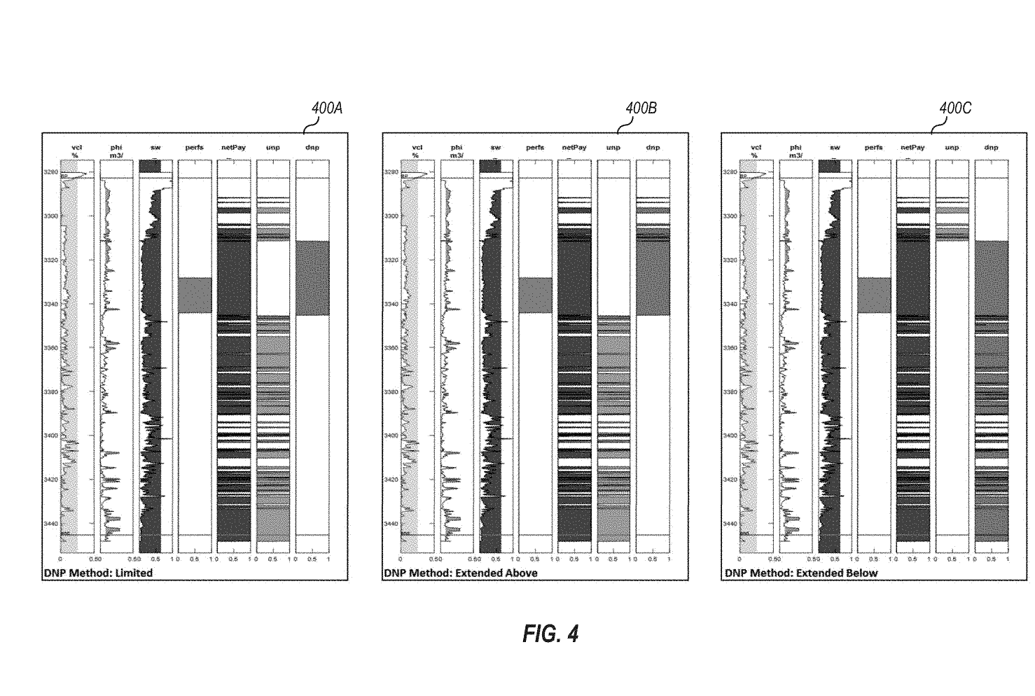

A drained net pay (DNP) log may be created in each well using an algorithm that incorporates the most recent completion data together with a net pay log reflecting various petrophysical cutoffs (e.g. porosity, permeability, water saturation, etc.). The algorithm tracks each net pay interval that is in direct or indirect communication with existing perforations. This tracking can also be customized to account for flow barriers (i.e. baffles). The characteristic attributes of what constitutes a baffle layer are provided by the user. For example, a pay interval that is separated from an existing perforation by a baffle will not (at least in some embodiments) be tracked or considered drained by the algorithm. The remaining pay that is not part of the DNP intervals is classified as uncontacted net pay (UNP) (charts 400A-400C of FIG. 4).

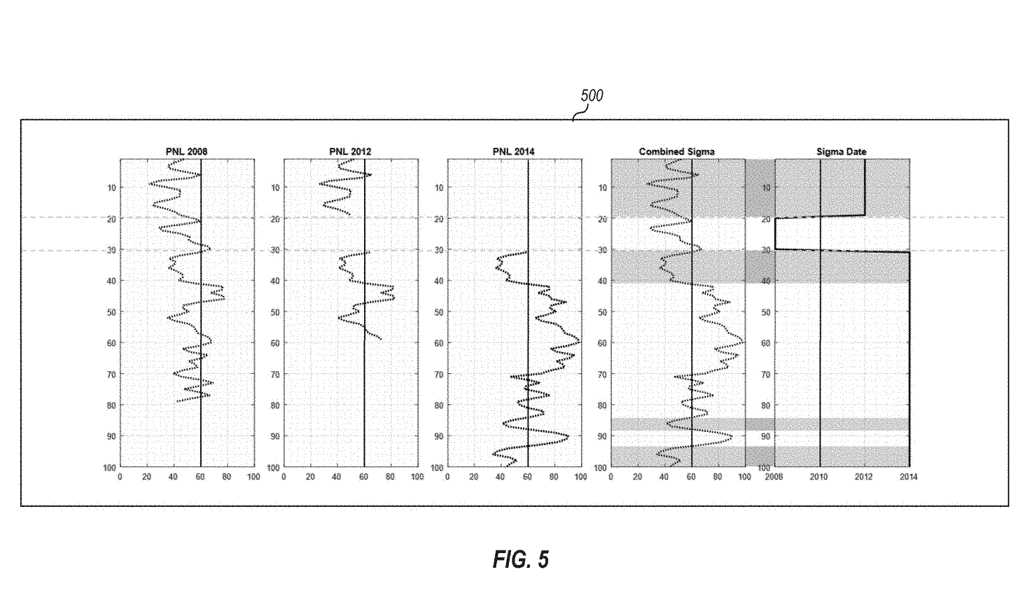

The algorithm can also be customized to make sure the uncontacted pay intervals are consistent with the particular perforation strategy adopted in the field, such as a top-down (400B) or bottom-up strategy (400C). In addition, the process of identifying these uncontacted pay intervals can be augmented with dynamic data sources. These can include recurrent log curves such as PNLs (Pulsed Neutron Logs) that probe the formation with neutrons and track water saturation at the time of the measurement. Since sequential PNL log runs do not necessarily cover the same depth intervals, the platform described herein can combine these curves together and create a corresponding date log that tracks the date stamp for every interval point (see chart 500 of FIG. 5). The user can then use this combined PNL log to filter through the UNP log.

Another way to integrate dynamic data is through the use of simulation models. Indeed, the user can choose to have the platform automatically derive pseudo logs from the current oil saturation property of simulation models (see chart 600 of Error! Reference source not found.). This is possible as long as the simulation model was fed as an input to the platform. The user can then use the oil saturation pseudo log to filter through the PNL log. Notice that, in chart 600, the resolution of the pseudo logs is much lower than that of the native logs which is why the pseudo logs are only used for UNP filtering purposes rather than for the identification of new target UNP intervals.

A drainage analysis is performed to ensure that the uncontacted net pay intervals identified in the previous phase have not been drained, or will not be drained, by offset wells. Drainage from each completion is characterized by coupling the results of the flow unit allocation module described above with the rock property logs. This analysis is performed on either a zone-by-zone basis if the zones constitute isolated flow units, or on a global basis in vertically connected systems.

During the drainage analysis, an algorithm estimates a drainage radius for every well/zone by relating the completed hydrocarbon pore volume thickness (HCPT) (estimated from the logs) to the allocated EUR or cumulative production in the completed zone. The algorithm also calculates a drainage index (DI) for each completed zone, which is a measure of vertical drainage efficiency. In other words, small DIs reflect areas where only thin sand layers have been accessed or drained, and therefore have more oil remaining in either overlying or underlying sand packages. Chart 700 of Error! Reference source not found. shows an example of a zone-specific drainage index grid that combines information from both the drainage radius and drainage index. Note that in areas with overlapping radii, the algorithm modifies the DI in the overlap area using either a pessimistic or optimistic method.

In heavily-fractured reservoirs, the produced oil is not confined to the local radii calculated above, but can also travel longer distances through fracture networks. To represent these patterns, the algorithm uses weighting functions that increase the DI away from the point of production. These weighting functions can also be directional to reflect fracture orientation if known. Using the drainage grids created during this phase, the uncontacted net pay intervals identified in Step 1 are filtered out if the zone DI at the opportunity location exceeds a user-provided DI cut-off.

The production forecasting phase of the workflow forecasts production for missed net pay opportunities. The predicted attribute is user-selected and can be either initial production (IP) or estimated ultimate recovery (EUR). Note that if IP is selected as the target attribute to predict, an EUR may be estimated using decline parameters of active neighborhood wells. Various forecast methods will be described further below.

A confidence estimation step involves two objectives: (1) to estimate the probability of exceeding (POE) the forecasted rate, and (2) to quantify the geologic uncertainty of a given opportunity. Once behind-pipe opportunities have been identified, and production has been forecasted, POE is estimated based on recovering the production target predicted in the previous phase. To estimate POE, the predicted target is compared to the performance of its neighborhood (STI or NFR forecast method). For each opportunity, a P10 and P90 IP/EUR is extracted from the analog well set, while the P50 is set to the result of the STI or the NFR method. To calculate the POE, the forecasted IP/EUR from the previous step is compared to the P10, P50, and P90 IP/EUR of the analog well set.

A geologic uncertainty step quantifies various aspects of geologic uncertainty. For recompletion opportunities, this step is primarily concerned with the structural uncertainty. This is quantified by considering the characteristics of complex structural elements like faults which can be sealing or leaking and might affect the connectivity and heterogeneity of the reservoir.

A mechanical feasibility step identifies which among the identified opportunities are mechanically feasible and which are not using wellbore diagrams. To do this, the algorithm uses a keyword scoring system from the user. This can be provided by the user in the parameters file found under a given project case, specifically in the following sheets ‘WBDKeywords’ and ‘WBDScores’, for the illustrated example, (chart 800 of Error! Reference source not found.). The first sheet 801 is provided in a graphical user interface, and asks the user to specify, by interaction with the graphical user interface, any and all keywords indicative of a potential problem in the borehole. The user is also asked to provide, in the graphical user interface, a score for each keyword. Higher scores should reflect increasing levels of problem difficulty. The description associated with each score is provided in the second sheet 802. When multiple keywords are identified in a given wellbore diagram, the platform will assign the opportunity the highest keyword score and its associated description. The description will be included in the automated report for further analysis by the user.

The final step in this workflow uses various opportunity attributes to filter the list of generated opportunities. These attributes are user-defined and can be, for example, any of the attributes shown in Table 1 below:

TABLE 1

| Well | Geologic/ | Production | Generic |
|---|---|---|---|
| Attributes | Log Attributes | Attributes | Attributes |
| Well status | HCPT | Production forecast | Stratigraphic zone |
| Well type | Permeability | WCT/GOR | Aerial block/ |
| | Resistivity | | segment |
| Production | Faults/Fractures | Drainage index | Custom |
| Date | | | Neighborhoods |

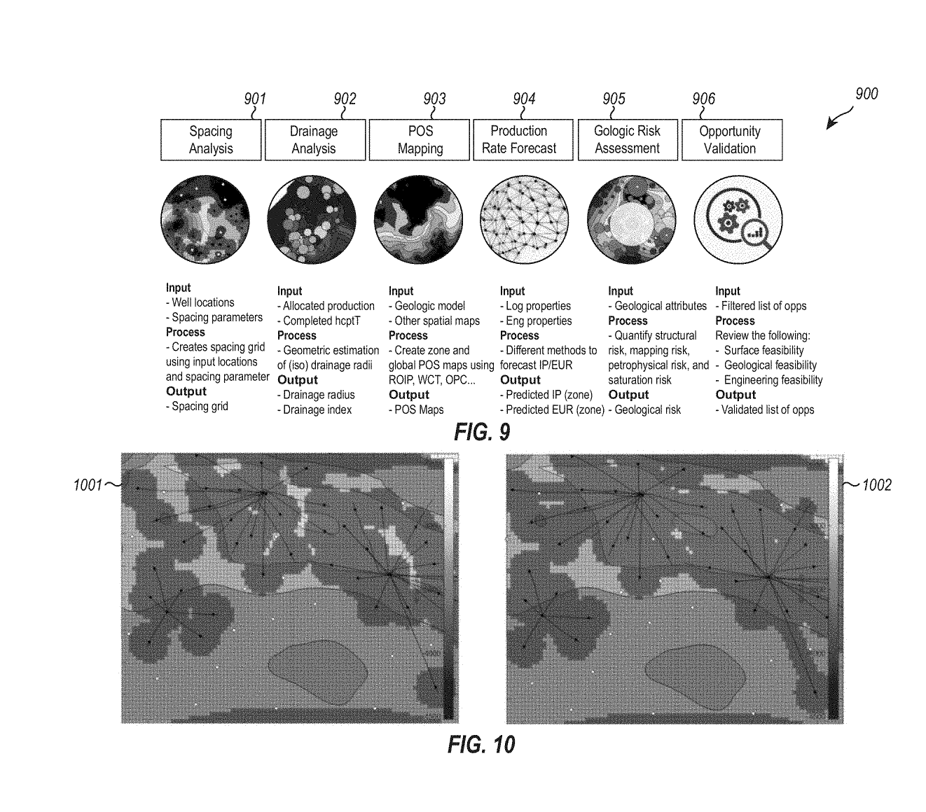

Turning now to the next embodiment, the workflow 900 for identifying new vertical drill locations shares many modules in common with the pay-behind pipe workflow, and adds additional steps to address more specific challenges with new drill opportunities (FIG. 9). The main modules are listed below: 1. 2D Spacing analysis module 901 identifies areas that fit the current field spacing constraints. 2. A drainage analysis module 902 identifies connections between wells. 3. A POS mapping module 903 generates a relative probability of success (RPOS) mapping which identifies areas with good potential. 4. A production forecast module 904 forecasts production for various target zones of each new drill location, 5. a geologic risk assessment module 905 estimates the probability of exceeding (POE) the forecast and relative geologic uncertainty, and 6. an opportunity validation module 906 filters new drill opportunities using a range of engineering and geologic attributes.

The spacing analysis module 901 aims at identifying surface areas that would not be fit for placing new wells because they do not respect the field spacing constraints (which may be user-provided). This is done by creating a spacing grid that differentiates no-go areas from open-access areas. The no-go areas can be identified using one of two methods (as shown in FIG. 10): in the well-head based method (1001), spacing is measured from the well head locations. For example, a 40-acres spacing parameter in this case means any area within 40-acres of an existing well head location is considered a no-go area. In the trajectory-based method (1002), spacing is measured along the full extent of the well trajectory.

This step of the workflow attempts to create a relative probability of success (RPOS) map that essentially ranks different areas according to various input attributes. This process starts by mapping RPOS for each stratigraphic zone independently using various user-specified input maps for the zone. An RPOS map for a particular zone might be mapped using any number of zone-mappable attributes such as: oil thickness, permeability, recent water cut, recent gas-oil ratio, cumulative production trends, fluid contact maps, drainage index map, proximity to faults, and so on. In addition, any attribute that can be reliably mapped can be used as an input to this mapping process (see the charts 1100 of Error! Reference source not found.11). Different mapping algorithms may be used in this process depending on the nature of the attribute to be mapped.

A zone RPOS map represents the aggregate of the normalized input attribute maps. A global RPOS map is created by combining trends in the individual zone RPOS maps. Since the individual zone RPOS maps were created using globally normalized input attribute maps, the global RPOS average map will weigh every zone appropriately, and will essentially reflect the aggregate quality from all the zones at any given location. The global RPOS map is used together with the spacing grid to identify locations that maximize RPOS while honoring the spacing grid constraints.

The forecasting step (904) estimates the production potential of each target zone in each new drill location. The predicted attribute is user-selected and can be either initial production (IP) or estimated ultimate recovery (EUR). Note that if IP is selected as the target attribute to predict, an EUR is estimated using decline parameters of active neighborhood wells. The confidence estimation step estimates the probability of exceeding (POE) the forecasted rate using neighborhood data, and further quantifies the geologic uncertainty of a given opportunity.

For new drill locations, the POE is estimated for each target zone separately. This is achieved by comparing the forecast of each target zone to the zone-specific neighborhood data (wells producing in the same zone). For any given zone, the methodology is therefore similar to how the POE is calculated for recompletion opportunities (see step 305 of the recompletion workflow in FIG. 3).

The geologic uncertainty step 905 quantifies various aspects of geologic uncertainty. For new drills, at least the following are considered: structural uncertainty and mapping uncertainty. Structural uncertainty is quantified by considering the characteristics of complex structural elements like faults which can be sealing or leaking and might affect the heterogeneity of the reservoir. When considering mapping uncertainty: the identification of new drills relies heavily on the quality of the geological mapping. Specifically, the platform considers the proximity of the target location to control data points (i.e. wells with logs that reach the opportunity target depth), and the distribution of these control data points. In other words, infill locations will have lower uncertainty because they are surrounded by control data from all directions, whereas step-out locations will have higher uncertainty since the mapping is only constrained from a single direction. In an attribute filtering step (906), the same types of attributes listed in the final step of the behind-pipe workflow are used to filter the new drill locations.

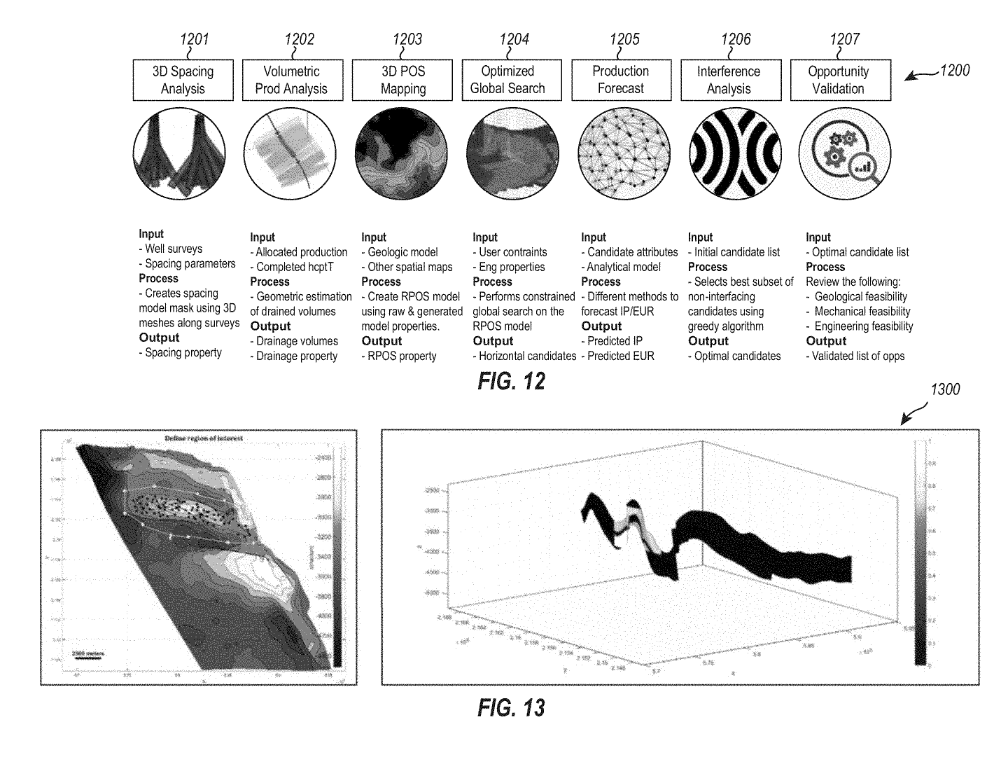

The workflow 1200 of FIG. 12 identifies optimal locations for placing horizontal or deviated wells in any type of reservoir. The algorithm creates a probability of success model that reflects trends in multiple user-defined geo-engineering attributes which is then used to perform a comprehensive 3D search that incorporates 3D pay tracking. The workflow to identify horizontal and/or deviated horizontal targets is independent from the vertical drill workflow. One reason for this is that there is a need for higher model resolution to place targets in specific sands. At least in some embodiments, this resolution cannot be achieved with a 2.5D model, which is what the vertical drill workflow relies on. As a result, the modules in this workflow are performed in full 3D space which allows for higher quality results. The main modules of this workflow are listed in FIG. 12): 1. optionally, a domain definition module (not shown) identifies cells of interest to constrain the analysis space. 2. A 3D spacing analysis module 1201 flags no-go cells based on spacing to avoid collisions with existing wells. 3. A volumetric production analysis module 1202 identifies cells drained by existing wells. 4. A 3D RPOS modelling module 1203 aggregates trends in multiple user-defined attributes. 5. An optimized global search module 1204 searches for optimal locations for well placement using user constraints. 6. A production forecast module 1205 forecasts an initial rate for the identified well target. 7. An interference analysis module 1206 identifies an optimal subset of non-interfering targets. 8. An opportunity validation module 1207 filters targets based on feasibility.

The first step of this workflow 1200 is the 3D domain definition. This allows the platform to identify the cells that are part of the domain of interest (Chart 1300 of FIG. 13). To do so, the user is given the option to provide the following constraints: 1) Stratigraphic constraints that specify specific formations, zones or layers to target in the analysis. This can be recommended when the user has prior knowledge of seal zones or non-reservoir formations that are not to be targeted. 2) Spatial constraints define a spatial region of interest that can be used by the algorithm to limit the lateral extent of the area to be searched. 3) Depth constraints define a depth range to restrict the analysis to. This can be used in situations when the user is aware of drilling limitations such as the deepest horizontal well that can be drilled with the current field technology. When combined, these constraints are not only helping the user articulate what constitutes a valid domain, but also help the algorithm reduce the computational cost and perform a more efficient and focused search.

The next step's objective (step 1201) is to prevent new targets from conflicting with existing well paths. To do this, the platform builds 3D meshes around existing well trajectories with a given spacing parameter. This results, in the illustrated example, in a set of curved 3D cylinders encompassing existing well surveys. These 3D meshes are then used to create a Boolean model property where cells are flagged if they are located within these 3D volumes (see charts 1400A & 1400B of Error! Reference source not found.). The resulting spacing property will later be incorporated in the POS model prior to the search.

Step 1202 performs the 3D equivalent of the 2D drainage analysis highlighted in the recompletion workflow (FIG. 3). However, due to the fact that it is performed in 3D space, there is no longer any need for the drainage index. The algorithm geometrically estimates the radius (and therefore 3D volume) that is going to be allocated to (or drained by) existing wells (see charts 1500A-1500C of Error! Reference source not found.). This analysis can be performed on a zone-specific basis as well using drained pay thickness in the zone together with the production allocated to it. To understand how drained pay thickness is derived or calculated, see step 301 of recompletion workflow 300 above.

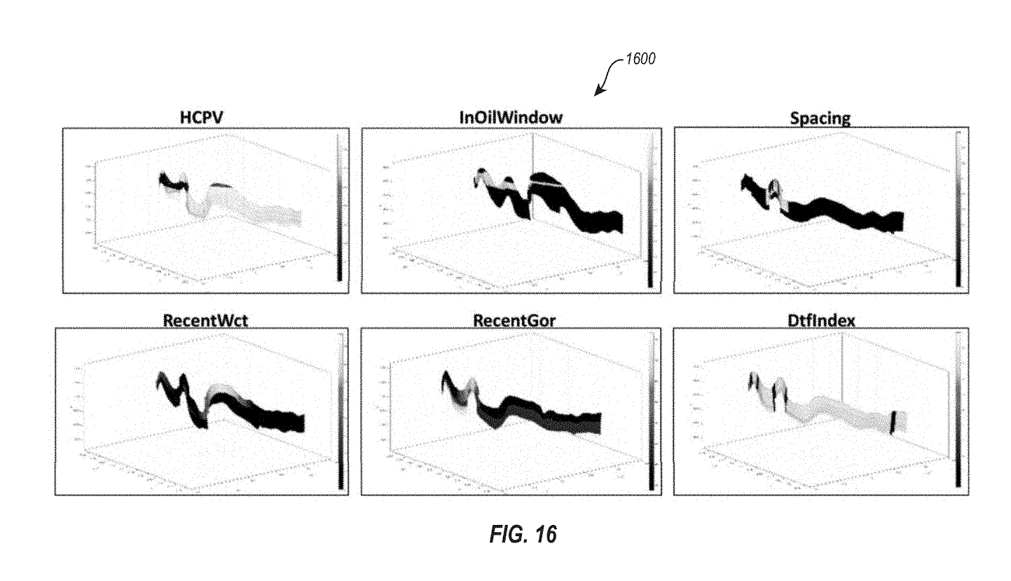

The objective of step 1203 is to create a 3D relative probability of success (RPOS) model property that aggregates trends in multiple user-defined attributes, especially those that are known to impact production. These can include geologic attributes such as current hydrocarbon pore volume, permeability, fracture intensity, and baffle layers as well as other geoengineering attributes such as spacing, drainage, water cut (WCT) and gas/oil ratio (GOR) trends, zone-specific fluid contacts, contact standoffs, and so on. The platform described herein automatically includes the domain and spacing attributes (see 1400A and 1400B of Error! Reference source not found.). The user can also include any other attribute as long as it has been imported as a model property. Note that this step is the 3D equivalent of the POS mapping step described in the vertical target identification workflow. Also note that some attributes like the WCT and GOR are upscaled within each zone so that each layer belongs to the same zone share the same lateral distribution, as generally shown in charts 1600 of FIG. 16.

Step 1204 uses a global search algorithm to find optimal well targets. This step maximizes a given user-provided attribute. By default, the algorithm maximizes a function of the POS along a given target. Prior to the start of the search, the 3D model is resampled to a uniform structure. This is because input models frequently come in a non-structured, non-uniform 3D grid where cell dimensions are not consistent across all cells, where pillars are not truly vertical, and where slices along the i or j vectors are not straight planes. Using such a model during the search will make the search incredibly slow because the index lookup requires a full 3D search that runs in polynomial time. Because index lookups are used countless time during the search, the inefficiency becomes even more pronounced. To speed up the search, this module (at 1204) will resample the input model to an orthogonal uniform 3D grid where cell dimensions are consistent. This leads to a little loss of information since some input cells will be aggregated, but the computational and efficiency gains largely compensate for it.

The search algorithm can be fed multiple types of constraints such as a length range, azimuth range, deviation range or other constraints. From the initial scan cells, the algorithm will only consider targets that honor these constraints. For each such target, the algorithm also performs a validation step to ensure it honors various path constraints. These path constraints are also user-provided and determine the spatial relationships between the target and other geological features. For each initial scan cell, the algorithm can save a number of valid targets that maximize or minimize the objective attribute (e.g. POS).

For each identified target that meets the configuration and path constraints, the algorithm tracks the pay cells connected directly or indirectly to the target in 3D space. This tracking is performed using an algorithm that recursively tracks pay cells in multiple user-specified directions. The algorithm starts to backtrack when it hits a baffle cell or layer and will try to continue the tracking in other directions until all directions have been fully explored. The algorithm was optimized to avoid redundant cell visits. This results in a faster algorithm with more efficient computational cost. The result is an effective pay thickness and drainage area that is used during the production forecast phase (described further below).

Step 1205 forecasts production for each of the identified and validated targets using a range of different techniques. These include statistical methods that leverage spatial and temporal neighborhood fluid data, machine learning techniques like supervised neural networks, analytical models specifically designed for horizontal wells, and simulation models. Step 1206 selects the best set of non-interfering candidates that optimize a given objective function (e.g., cumulative production, Net Present Value (NPV), or operation time functions). Interference between two targets is defined when their respective drainage volumes overlap in space. One objective in this step is to maximize production, which is why this step is described after the production forecast in this workflow. However, because the initial set of identified targets can be well into the thousands, the production forecast cannot be run in a realistic time due to the cost of performing pay tracking on all of them. Therefore, by default, the interference algorithm is set to select the set of non-interfering candidates that maximizes POS.

A series of methods have been developed to forecast a production attribute (IP and/or EUR) for any type of identified opportunity. The predicted attribute is pre-defined and can be initial production (IP) or estimated ultimate recovery (EUR). Note that if IP is selected as the target attribute to predict, the EUR is estimated using decline parameters of active neighborhood wells. Table 2 below lists the available forecast methods and summarizes the pros and cons of each one.

TABLE 2

| Method | Advantages | Limitations |
|---|---|---|
| ANN | Incorporates wealth of | Overlearning/memorization |
| | GEO/ENG attributes | Sensitive to training dataset size |
| | Captures complex relationships | |
| ZTC | Captures temporal trends | Spatially unaware |
| | Can be normalized with static | Can have a large range of uncertainty |
| | variables (kh) | |
| NFR | Neighborhood fluid rates | Will underestimate potential |
| | Uses zone-specific fluid rates | Limited by availability of neighborhood |
| | | data |
| TNNFR | Thickness-Normalized NFR | Limited by availability of neighborhood |
| | Fluid rates normalized with perf | data |
| | length | |
| STI | Captures spatial and temporal | Sensitive to user-provided weights |
| | trends | |
| | Various weighting functions to | |
| | choose from | |
| DARCY | Physics-based forecast method | Requires fine-tuning. Inputs are not |
| | for vertical wells | always available. |
| Analytical | Analytical methods specifically | Requires fine-tuning. Inputs are not |
| Models | designed for horizontal wells | always available. |

Artificial Neural Networks (ANN's) are used to develop a model that relates the production performance to a series of data attributes including petrophysical interpretations, geological properties, and various engineering attributes. The training set used to train the model include past completion intervals, and the training attributes are derived or calculated specifically over these intervals. Once the model is trained, the testing dataset is collected by deriving the testing attributes specifically over the target uncontacted pay intervals. Table 3 below shows various training attributes together with their corresponding testing attributes. While neural networks can incorporate relationships between several attributes, their reliability depends on the size of the training dataset.

TABLE 3

| | TRAINING ATTRIBUTES | | TESTING ATTRIBUTES | |
|---|---|---|---|---|
| | INPUT | TARGET | INPUT | TARGET |
| | ATTRIBUTES | ATTRIBUTE | ATTRIBUTES | ATTRIBUTE |
| Log Based | DNP MD | Allocated IP | UNP MD | Allocated IP |
| Attributes | Thickness | OR | Thickness | OR |
| | Hcpt DNP | Allocated | Hcpt UNP | Allocated EUR |
| | Resistivity DNP | EUR | Resistivity | |
| | | | UNP | |
| | Permeability | | Permeability | |
| | DNP | | UNP | |
| | Other Logs in | | Other Logs in | |
| | DNP | | UNP | |
| Geo- | Cumulative | | Most Recent | |
| Engineering | WCT | | WCT | |
| Attributes | Cumulative | | Most Recent | |
| | GOR | | GOR | |
| | Lift Type | | Desired Lift | |
| | | | Type | |
| | Initial Pressure | | Current | |
| | | | Pressure | |
| | Distance to | | Distance to | |
| | faults | | faults | |
| | Etc. | | Etc. | |

This method uses zone-specific production type curves normalized by static variables such as permeability-thickness. While this method is generally good in capturing temporal trends in zone production, it fails to capture spatial variation in production performance.

Neighborhood Fluid Rates (NFR): Current zone-allocated fluid rates in the neighborhood around the opportunity (neighborhood size may be user-defined) are normalized by perforation length to create fluid rate indices (FRIs). The neighborhood wells can also be restricted to only those that are of the same type as the target opportunity (i.e. horizontal vs. vertical wells). The FRIs are interpolated to opportunity location using inverse-distance weighting. The interpolated FRI is then used to calculate IP as follows:

IP=Interpolated FRI×UNP×(1−WCT)

where “Interpolated FRI” is the interpolated FRI at the opportunity location, “UNP” is the uncontacted net pay thickness in the target zone, and “WCT” is the recent zone water cut of the nearest-neighbor well producing in the same target zone. Note that this method indirectly incorporates local pressure information since it relies on neighborhood fluid rates. However, the use of current fluid rates means the predicted target will likely be a low-side estimate.

An analog well set may be defined for each opportunity. The analog well set is defined as the set of wells producing from the opportunity's target zone, and located within the spatial neighborhood (i.e. within radius R or part of N closest points), and within the temporal neighborhood (i.e. started producing within the last M years). Note that the neighborhood parameters R, N, and M are user-defined. The analog well set can also be restricted to wells that are of the same type as the target opportunity (i.e. horizontal vs. vertical target). Each analog well is assigned a spatial and temporal weight that reflects spatial and temporal proximity respectively using various weighting functions such as sigmoidal or Gaussian functions. The forecast is calculated by interpolating the IPs/EURs of the analog wells using their assigned weights.

A physics-based method to forecast initial rate of a given opportunity is described herein. This particular implementation is only valid for vertical recompletion opportunities or new vertical wells (for physics-based method applicable to horizontal wells, see below). The formula is as follows:

$$IP = PI \times Δ P = \frac{c \times k \times h}{μ \times FVF \times log ( \frac{Re}{Rw} )} \times Δ P$$

Where ΔP: pressure drawdown, PI: productivity index, c: unit conversion constant, k: permeability, h: net pay thickness, FVF: formation volume factor, Re: drainage radius, and Rw: wellbore radius.

To determine a forecast rate for horizontal wells, a suite of analytical models has been implemented. The models have been adapted herein to solve more complicated partial differential equations (PDEs) coupled with more realistic boundary conditions (BCs) to significantly improve the speed and accuracy of these forecasting techniques. Their descriptions are provided below:

Joshi Model: The steady-state flow model developed by Joshi (1988) is one of the first and most well-known analytical models for horizontal well inflow. Joshi derived an equation for the flow rate to a horizontal well of length “L” by adding a solution for the flow resistance in the horizontal plane with the solution for the flow resistance in the vertical plane, and taking into account vertical-to-horizontal anisotropy.

Babu Model: Pseudo steady-state models of inflow performance presume that the reservoir is bounded by no-flow boundaries and that pressure declines in a uniform fashion in the reservoir. In the Babu and Odeh (1988, 1989) models, the physical system is a box-shaped drainage area. A shape factor is adapted to account for the drainage area change and also account for partial penetration skin.

Furui Model: Furui et al (2003) describe another steady-state analytical flow model for horizontal well inflow. Furui et al. solve the flow problem in the cross-sectional area perpendicular to the wellbore. The model assumes the flow near the well is radial and becomes linear farther from the well. The drainage area for this model is a box-shaped reservoir, and the forecasts are based on simulation results of a finite element model for an incompressible fluid.

Economides et al. (1991) developed a general model for one or more horizontal wells or laterals by integrating unit length point sources in no-flow boundary boxes to create an arbitrary well trajectory or trajectories. This modeling approach will enable many useful models for both transient and pseudo steady-state flow behavior of vertical, deviated, and horizontal wells with and without fractures. The concepts above will be explained further below with regard to methods 1700, 1800 and 1900 of FIGS. 17, 18 and 19, respectively.

In view of the systems and architectures described above, methodologies that may be implemented in accordance with the disclosed subject matter will be better appreciated with reference to the flowcharts of FIGS. 17, 18 and 19. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 17 illustrates a flowchart of a method 1700 for identifying and implementing hydrocarbon production opportunities including recompletion opportunities. The method 1700 will now be described with frequent reference to the components and data of environment 100 of FIG. 1.

Method 1700 includes accessing one or more portions of petrophysical log data obtained at a hydrocarbon extraction site to generate a geological map of the site (1710). For example, data accessing module 107 may access petrophysical log data 135 obtained at hydrocarbon extraction site 130. The geological map generator 108 may generate a geological map 110 based on this petrophysical log data 135. The data accessing module 107 may also access historical completion data 141 for the hydrocarbon extraction site 130 to identify uncontacted net pay intervals (1720). These uncontacted net pay intervals represent material 132 remaining in hydrocarbon wells 131 on the hydrocarbon site (1720). As noted above, many wells are initially mined for a period of time, and when mining becomes economically unfeasible, the mining equipment is moved to more profitable wells. Thus, existing wells may still have uncontacted material 132 in them.

Method 1700 includes analyzing isolated and connected intervals of the hydrocarbon wells to determine, according to the geological map, which portions of the hydrocarbon wells have been drained by existing completions (1730). The drainage analyzer 109 of computer system 101 may analyze isolated and connected intervals in the hydrocarbon wells 131 to determine, using the generated geological map 110, which portions of the hydrocarbon wells 131 have been previously drained by prior existing completions 133. By determining which portions of material have been withdrawn and which portions remain, the platform described herein can determine whether it would be economically profitable to place a rig (or other completions equipment) at a given well in an attempt to harvest the remaining material 132. The drainage analysis results 110 may be presented to a user or may be used by other modules to perform calculations or estimations.

Method 1700 next includes forecasting, using statistical neighborhood methods and one or more machine learning algorithms, projected production results for one or more recompletion opportunities at the hydrocarbon site, the projected production results including initial production estimates and/or ultimate recovery estimates (1740). The forecasting module 112 of computer system 101 may use statistical neighborhood methods and/or machine learning algorithms 113 to forecast projected production results 114. These projected results may indicate how much remaining material 132 is likely to be produced during an initial term (i.e. initial production estimate 115) and over the life of the well (i.e. ultimate recovery estimate 116).

The uncertainty calculation module 117 may then calculate a level of geologic uncertainty 118 relative to the forecasted production results 114 and determined drainage 110 (1750). The geologic uncertainty levels 118 indicate levels of risk 113. The risk level accounts for various unknowns in the drilling process including how much material is actually remaining, how many of the wells are interconnected, how many different rock formations exist, different pressures, the presence of other materials, etc. Many factors may make placing a well in a given zone 134 more or less risky in terms of ultimate production from the well. In some cases, calculating the level of geologic uncertainty 118 relative to the forecasted production results 114 and determined drainage 110 may include identifying structural risks, mapping risks, petrophysical risks, saturation risks or other types of risk.

Method 1700 next includes filtering a list of recompletion opportunities for selection according to geological feasibility, mechanical feasibility and/or engineering feasibility (1760). The filtering module 120 of computer system 101 may filter a list of target recompletion opportunities 121 that are available within a given hydrocarbon extraction site 130. Each target opportunity will have different levels of feasibility, especially when taking into account geological, mechanical and engineering feasibility. The filtering module 120 may sort through possible recompletion opportunities to identify those that best match a given location. Once a recompletion opportunity has been identified by the well target identifier 124, the computer system 101 sends a signal 128 to initiate production at that well (1770). Further commands may also be sent controlling how the oil is produced. Indeed, in at least some embodiments, controls from the computer system directly control equipment and/or processes at the hydrocarbon extraction site 130.

The computer system 101 may also access wellbore diagrams of at least one of the hydrocarbon wells 131 to mine additional information that further aids in determining which recompletion opportunities are feasible. In some cases, experts such as petrophysicists may assist in determining feasibility of drilling at an existing completion 133. Vetted petrophysical interpretations may be used to create a geological model (or map 110) that shows the spatial distribution of specified geological properties for each formation or zone. This geological map 110 may be used to analyze drainage in the well, and may further be used in the production forecast 114.

As part of the drainage analysis, the isolated and connected intervals of the hydrocarbon wells may be analyzed to determine intervals that have been drained by existing completions 133. This process may include tracking net pay intervals that are in direct or indirect communication with existing perforations. This process of tracking net pay intervals may be customizable to account for baffle layers or other flow barriers, current fluid contacts, perforation strategy (i.e. top-down vs bottom-up), and saturation data derived from recurrent measurements (such as Pulsed Neutron Logs) or from dynamic simulation models. Still further, analyzing isolated and connected intervals of the hydrocarbon wells to identify drainage may include creating a drainage grid. Within this drainage grid, each formation uses the production volume or estimated ultimate recovery allocated to the formation in each hydrocarbon well.

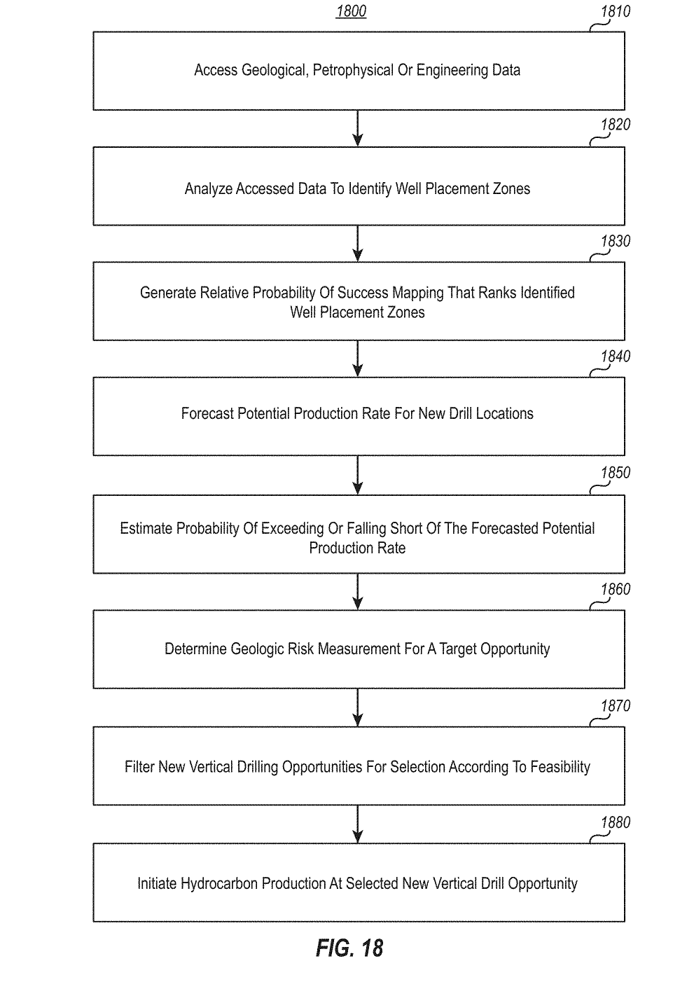

FIG. 18 illustrates a flowchart of a method 1800 for identifying and implementing hydrocarbon production opportunities including new vertical drill target opportunities. The method 1800 will now be described with frequent reference to the components and data of environment 100 of FIG. 1.

Method 1800 includes accessing one or more portions of geological, petrophysical or engineering data related to a hydrocarbon extraction site (1810). For example, the data accessing module 107 may access petrophysical log data 135, geological log data 136, and/or engineering data 137 related to the hydrocarbon extraction site 130. This data may be received directly from the site, or may be retrieved from a data store such as data store 140.

Method 1800 next includes analyzing the accessed data to identify one or more well placement grid cells in the hydrocarbon extraction site that are fit for placing new wells according to one or more well placement constraints (1820). The processor 102 of computer system 101 may analyze the data 135-137 to identify well placement grid cells (134) that are suitable for placing new wells based on specified constraints. The well placement constraints may be specific to a given hydrocarbon extraction site 130, or may be specific to certain well placement zones 134.

Method 1800 further includes generating a relative probability of success (RPOS) mapping for each zone that ranks the identified well placement grid cells according to one or more zone-mappable attributes associated with productive hydrocarbon wells (1830). For instance, the probability of success calculation module 122 may implement a map generator 123 to create an RPOS mapping 127 for each zone that ranks each identified well placement grid cell according to various attributes 126. These attributes may include well attributes, geologic/log attributes, production attributes or generic attributes, as shown in Table 1 above.

The forecasting module 112 of computer system 101 then forecasts, for each new drill location, a potential production rate for one or more target zones (1840), and estimates the probability of exceeding or falling short of the forecasted potential production rate using neighborhood characterization data 142 indicating an amount that wells in neighboring zones are producing (1850). The neighborhood production data 142 thus provides an indication of how much material other zones in a given area are producing. This data may be used to estimate whether a new drill location will likely fall short of or exceed a forecast for that location.

Then, the geologic uncertainty calculation module 117 determines, based on geologic factors related to the hydrocarbon site, a geologic risk measurement 113 for a given target opportunity (1860). The risk measurement indicates the heterogeneity of the reservoir and the quality of the geological distribution 110. The filtering module 120 then filters a list of new vertical drilling opportunities for selection according to geological feasibility, operational constraints and/or engineering feasibility (1870), and upon the well target identifier 124 selecting one of the feasible wells (and potentially the most feasible well), hydrocarbon production is initiated at the selected new vertical drilling opportunity (1880) by sending the signal 128.

In some embodiments, analyzing the data 135-137 to identify well placement zones 134 in hydrocarbon extraction site 130 that are fit for placing new wells according to well placement constraints includes creating a spacing grid to perform the well placement analysis (see 1001 and 1002 of FIG. 10). Determining optimal well placement may also include performing a drainage analysis to analyze isolated and connected intervals of the hydrocarbon wells. This is done in order to determine which portions of the hydrocarbon wells have been drained by existing completions. The well placement analysis may use drainage information to assist in determining where to place the new well.

Optionally, a global relative probability of success (RPOS) map may be generated that aggregates the RPOS for each stratigraphic zone. Each global RPOS map (e.g. 127) may be generated using multiple spatial attributes that are known to affect production performance. Using such a map (along with other information outlined above) sweet spots may be identified for placing new vertical wells that maximize the global RPOS while honoring the well placement constraints. This results in a well placement that is most likely to produce the highest amount of hydrocarbon returns. Geological uncertainty also plays a role in new well placement. The geological uncertainty associated with each new drill location may be quantified using algorithms that assess the uncertainty of structural interpretations and the geologic risk as indicated by the availability and distribution of control data points. Any or all of this information may be used to identify the optimal location to place a new vertical well.

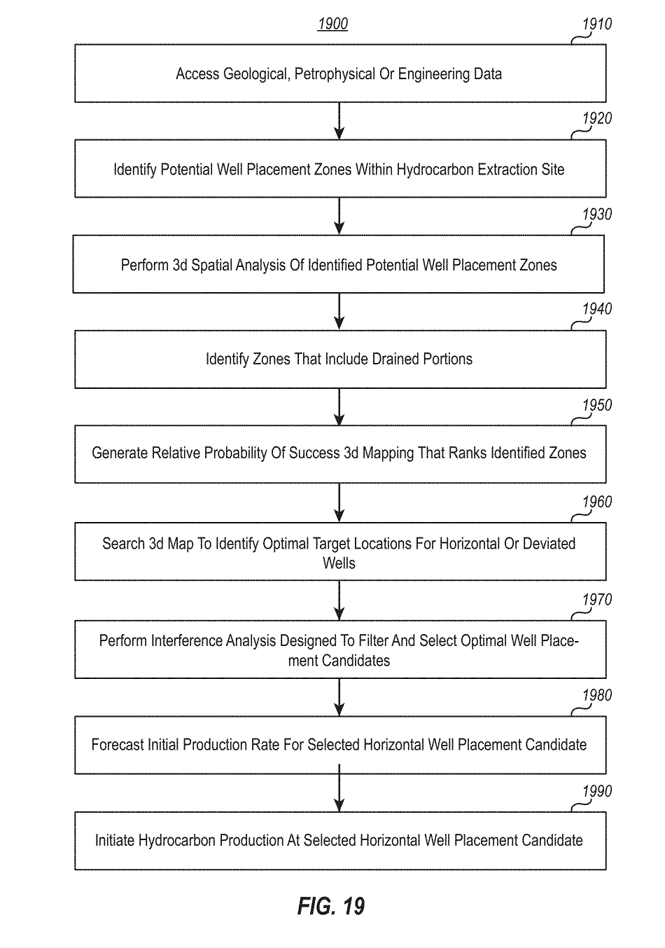

FIG. 19 illustrates a flowchart of a method 1900 for identifying and implementing hydrocarbon production opportunities including horizontal or deviated well target opportunities. The method 1900 will now be described with frequent reference to the components and data of environment 100 of FIG. 1.

Method 1900 includes accessing one or more portions of geological, petrophysical or engineering data related to a hydrocarbon extraction site (1910). The data accessing module 107 accesses petrophysical, geological and/or engineering data (135-137) and uses that data to identify potential regions that satisfy one or more stratigraphic, spatial and depth constraints within the hydrocarbon extraction site (1920). The geological map generator 108 performing a 3D spatial analysis of the identified potential well placement zones within the hydrocarbon extraction site (1930).

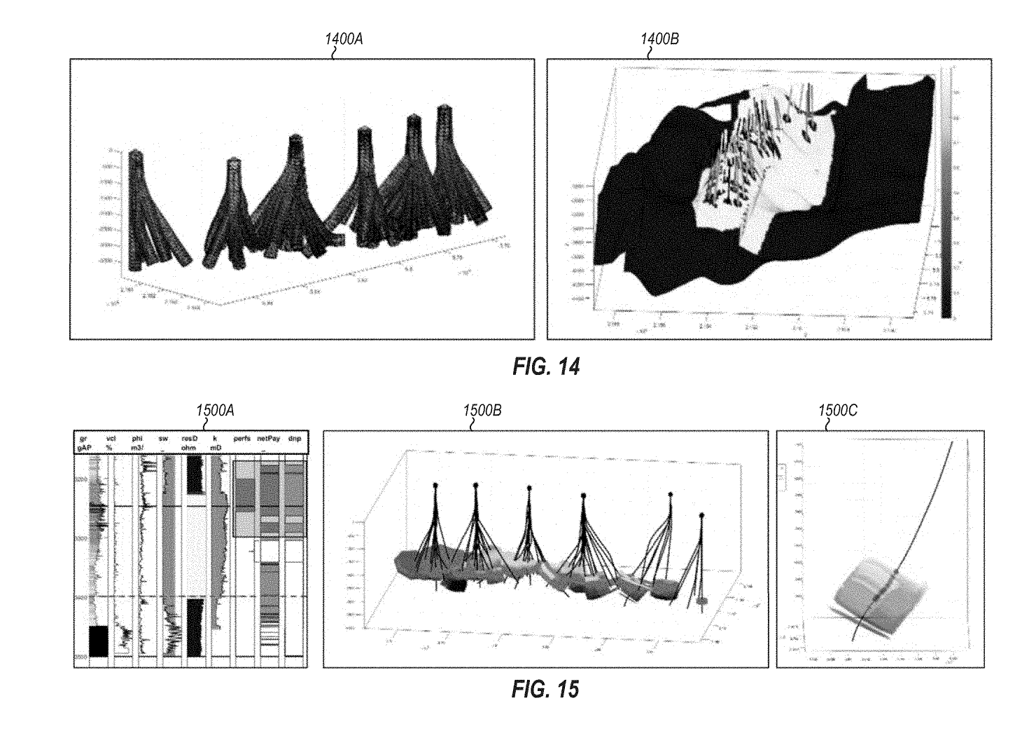

In some cases, the 3D spatial analysis includes generating a Boolean spacing grid. The Boolean spacing grid includes three dimensional (3D) meshes wrapped around existing well trajectories with a given spacing parameter. This results in a set of curved 3D cylinders that are used to create a model mask indicating which cells satisfy the spacing constraints (see FIGS. 14 & 15). This 3D spatial analysis may include or may be a precursor to identifying zones of the hydrocarbon extraction site that include drained portions that have been drained by existing wells on the site (1940). Such a drainage analysis, as in the embodiments above, identifies which portions of material have been drained and which are still present and perhaps uncontacted.

The probability of success calculation module 122 generates a relative probability of success (RPOS) 3D map 127 that ranks the identified zones of the site (in ranking 125) according to zone-mappable attributes 126 associated with productive hydrocarbon wells (1950). The well target identifier 124 then searches this 3D map 127 to identify optimal target locations for horizontal or deviated wells according to the RPOS 3D map and according to various well placement constraints including azimuth, target length, or deviation range as defined by a user (1960). The RPOS 3D map include a 3D map of model properties that aggregates trends in multiple user-defined attributes, including those attributes that are known to impact hydrocarbon production. Once the 3D map is generated, the filtering module 120 may then perform an interference analysis designed to filter through and select an optimal set of non-interfering well candidates (1970). At least in some cases, the interference analysis may use a greedy algorithm. This greedy algorithm may be performed on the identified targets to select an optimal subset of non-interfering candidates that optimize a user-selected objective function (e.g. a cumulative production, Net Present Value, or operation time function).

Once the well candidates 121 have been identified, the forecasting module 112 may be used to forecast an initial production rate 115 for the selected horizontal well placement candidate placed in the identified location on the hydrocarbon extraction site using analytical, simulation, or machine learning models (1980). After the forecast has been generated and the optimal well site(s) has/have been chosen, the computer system 101 may initiate hydrocarbon production at the selected horizontal well placement candidate in the identified location (1990) by sending the signal 128 to the appropriate person, group, computer system or other entity.

In some cases, initiating hydrocarbon production at the selected horizontal well in the identified location may include providing control instructions that direct operation of the selected target. This could include controlling equipment, computing systems, sensors, electronics or other devices or systems. When identifying well targets to initiate, the well target identifier 124 may be configured to identify potential horizontal or deviated well targets using an optimized global search. The optimized global search may incorporate multiple search constraints including well configuration constraints and path constraints.

Other constraints and algorithms may be used to track how much material is produced once production has been initiated. For instance, a pay tracking analysis may use a recursive algorithm on the identified targets to determine the vertical and lateral extent of pay cells in communication with the grid cells penetrated by the target. This measurement of pay cells may provide a good indication of how much material has been (or will be) produced at the well.

Accordingly, methods, systems and computer program products are provided which identify and implement hydrocarbon production opportunities including recompletion opportunities, new vertical drill target opportunities, and horizontal or deviated well target opportunities. The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A method, implemented at a computer system that includes at least one processor, for identifying and implementing hydrocarbon production opportunities including recompletion opportunities, the method comprising:
accessing one or more portions of petrophysical log data obtained at a hydrocarbon extraction site to generate a geological map of the site;
accessing one or more portions of historical completion data for the hydrocarbon extraction site to identify uncontacted net pay intervals, the uncontacted net pay intervals representing material remaining in one or more hydrocarbon wells on the hydrocarbon site;
analyzing isolated and connected intervals of the hydrocarbon wells to determine, according to the geological map, which portions of the hydrocarbon wells have been drained by existing completions;
forecasting, using statistical neighborhood methods and one or more machine learning algorithms, projected production results for one or more recompletion opportunities at the hydrocarbon site, the projected production results including initial production estimates and/or ultimate recovery estimates;
calculating a level of geologic uncertainty relative to the forecasted production results and determined drainage, wherein the geologic uncertainty levels indicate levels of risk;
filtering a list of recompletion opportunities for selection according to geological feasibility, mechanical feasibility and/or engineering feasibility; and
initiating hydrocarbon production at at least one of the recompletion opportunities.

2. The method of claim 1, further comprising accessing one or more wellbore diagrams of at least one of the hydrocarbon wells to mine additional information indicating which recompletion opportunities are feasible.

3. The method of claim 1, wherein vetted petrophysical interpretations are used to create a geological model that shows the spatial distribution of specified geological properties for each formation or zone.

4. The method of claim 1, wherein analyzing isolated and connected intervals of the hydrocarbon wells to determine intervals that have been drained by existing completions includes tracking net pay intervals that are in direct or indirect communication with existing perforations.

5. The method of claim 4, wherein the tracking of net pay intervals is customizable to account for baffle layers or other flow barriers, current fluid contacts, perforation strategy, and saturation data derived from recurrent measurements or from dynamic simulation models.

6. The method of claim 1, wherein analyzing isolated and connected intervals of the hydrocarbon wells to determine which portions of the hydrocarbon wells have been drained includes creating a drainage grid, each formation using the production volume or estimated ultimate recovery allocated to the formation in each hydrocarbon well.

7. The method of claim 1, wherein calculating the level of geologic uncertainty relative to the forecasted production results and determined drainage includes determining at least one of structural risks, mapping risks, petrophysical risks or saturation risks.

8. One or more computer-readable media that store computer-executable instructions that, when executed, implement a method for identifying and implementing hydrocarbon production opportunities including new vertical drill target opportunities, the method comprising:
accessing one or more portions of geological, petrophysical or engineering data related to a hydrocarbon extraction site;
analyzing the accessed data to identify one or more well placement grid cells in the hydrocarbon extraction site that are fit for placing new wells according to one or more well placement constraints;
generating a relative probability of success (RPOS) mapping for each zone that ranks the identified well placement grid cells according to one or more zone-mappable attributes associated with productive hydrocarbon wells;
forecasting, for each new drill location, a potential production rate for one or more target zones;
estimating the probability of exceeding or falling short of the forecasted potential production rate using at least a portion of neighborhood production data indicating an amount that wells in neighboring zones are producing;
determining, based on one or more geologic factors related to the hydrocarbon site, a geologic risk measurement for a given target opportunity, the risk measurement indicating the connectivity of the reservoir and the quality of the geological mapping;
filtering a list of new vertical drilling opportunities for selection according to geological feasibility, mechanical feasibility and/or engineering feasibility; and
initiating hydrocarbon production at the selected new vertical drilling opportunity.

9. The computer-readable media of claim 8, wherein analyzing the accessed data to identify one or more well placement zones in a hydrocarbon extraction site that are fit for placing new wells according to one or more well placement constraints comprises creating a Boolean spacing grid to perform the well placement analysis.

10. The computer-readable media of claim 8, further comprising performing a drainage analysis configured to analyze isolated and connected intervals of the hydrocarbon wells to determine which portions of the hydrocarbon wells have been drained by existing completions.

11. The computer-readable media of claim 8, further comprising generating a global relative probability of success (RPOS) map that aggregates the RPOS for each stratigraphic zone, each global RPOS map being generated using multiple spatial attributes that are known to affect production performance.

12. The computer-readable media of claim 11, further comprising selecting one or more sweet spots for placing new vertical wells that maximize the global RPOS while honoring the well placement constraints.

13. The computer-readable media of claim 8, wherein the geological uncertainty associated with each new drill location is quantified using algorithms that assess the uncertainty of structural interpretations and the geologic risk as indicated by the availability and distribution of control data points.

14. A computer system for identifying and implementing hydrocarbon production opportunities including horizontal or deviated well target opportunities, comprising:
one or more processors;
system memory;
a data accessing module configured to access one or more portions of geological, petrophysical or engineering data related to a hydrocarbon extraction site;
a domain identifier configured to identify potential regions that satisfy one or more stratigraphic, spatial and depth constraints within the hydrocarbon extraction site;
a spatial analyzer configured to perform a 3D spatial analysis of one or more of the identified potential well placement zones within the hydrocarbon extraction site;
a drainage analyzer configured to identify one or more zones of the hydrocarbon extraction site that include drained portions that have been drained by existing wells on the site;
a 3D map generator configured to generate a relative probability of success (RPOS) 3D map that ranks the identified zones of the site according to one or more zone-mappable attributes associated with productive hydrocarbon wells;
a well target identifier configured to search the 3D map to identify optimal target locations for horizontal or deviated wells according to the RPOS 3D map and one or more well placement constraints including at least one of azimuth, target length, or deviation range as defined by a user;
an optimization module configured to perform an interference analysis designed to filter through and select an optimal set of non-interfering well candidates;
a forecasting module configured to forecast an initial production rate for the selected horizontal well placement candidate placed in the identified location on the hydrocarbon extraction site using one or more analytical, simulation, or machine learning models; and
a production initiator configured to initiate hydrocarbon production at the selected horizontal well placement candidate in the identified location.

15. The system of claim 14, wherein the Boolean spacing grid includes three dimensional (3D) meshes wrapped around existing well trajectories with a given spacing parameter, resulting in a set of curved 3D cylinders that are used to create a model mask indicating which cells satisfy the spacing constraints.

16. The system of claim 14, wherein the RPOS 3D map comprises a 3D map of model properties that aggregates trends in multiple user-defined attributes, including those attributes that are known to impact hydrocarbon production.

17. The system of claim 14, wherein the well target identifier is configured to identify potential horizontal or deviated well targets using an optimized global search that incorporates a plurality of search constraints including well configuration constraints and path constraints.

18. The system of claim 14, wherein a pay tracking analysis using a recursive flood fill algorithm is performed on the identified targets to determine the vertical and lateral extent of pay cells in communication with the grid cells penetrated by the target.

19. The system of claim 14, wherein an interference analysis using a greedy algorithm is performed on the identified targets to select an optimal subset of non-interfering candidates that optimize a user-selected objective function.

20. The system of claim 14, wherein initiating hydrocarbon production at the selected horizontal well in the identified location comprises providing one or more control instructions that direct operation of the selected target.
